(19) United States
(12) Patent Application Publication
(10) Pub. No.: US 2006/0177004 A1
(43) Pub. Date: Aug. 10, 2006

(54) Apparatus and method for monitoring network resources

(75) Inventor: Adrian Gilbert, Ottawa (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: N-Able Technologies International, Inc., Dover, DE (US)

(21) Appl. No.: 11/043,396

(22) Filed: Jan. 26, 2005

(51) Int. Cl. H04M 11/04

(52) U.S. Cl. 379/40

(57) ABSTRACT

A method and apparatus for monitoring network resources is disclosed. Code for use in instructing components in a network monitoring system is provided. The components include at least one data gathering for gathering operation data from a monitor network constituent. A main computer system has a database for storing the operation data. A data forwarder permits communication of the operation data from the data gather to the computer system. The computer system is remotely located from the data gatherer. The code includes information for creating custom tables in the database to hold the operation data. Information permits the data gatherer to selectively gather the operation data from other possible data that is capable of being gathered from the monitor constituent.

### FIELD OF THE INVENTION

The present invention relates to a method and apparatus for monitoring network resources and, in particular, to the intelligent gathering and processing of operation data from monitored network resources.

### BACKGROUND OF THE INVENTION

If the computer systems of a business cease operating properly or fail, business functions may not be executed efficiently, and in a worst case scenario, they may not be executed at all. In response to this concern, tools have been developed to monitor these systems. Some of these tools have come to be known as network management systems. Network management systems can have functions including fault management and performance management.

In one type of network management system, an agent residing on a client's server monitors specified server functions. Anomalies or problems with the client network are reported to an on-site central management centre for an IT professional to address. An example commercially available, network monitoring solution of the type described is the Hewlett Packard HP Openview™ system. HP Openview™ is a system that is installed on a subject network for monitoring its availability and performance. In the event of imminent or actual network failure, IT staff is notified so that proper measures can be taken to correct or prevent the failures.

It is known to provide a network monitoring solution in which the information of interest is displayed on a web dashboard. This dashboard can rank issues (graphically or in a less visual manner) by severity. Also, some monitoring solutions provide the ability to generate reports over monitored time periods.

Not all network resources are performance evaluated in the same manner. Internet services such as POP3, HTTP, HTTPS, DNS, FTP and SMTP are usually tracked for latency. Oracle and SQL database servers can be monitored for port responsiveness.

United States Patent Application Pub. No. 2004/0030778 A1 discloses a method, apparatus, and article of manufacture for a network monitoring system. Software on a remote monitoring system (RMS) server spawns a copy of itself for each service, sensor, device or agent that the RMS server is configured to monitor. In the case of an anomaly or a non-responsive service, the RMS server can send information regarding the issue to a network operation site in the form of a Standard Generalized Markup Language (SGML) document. The SGML document describes the problem, and includes SGML tags to identify a client site, the effected device location and address, and the malfunctioning service name. Also the RMS server disclosed in this patent reference can examine various log files associated with a particular device, to send to a central accounting system (CAS) server for processing and dispatch.

As discussed, it is desirable for hardware devices that are located on a network to be monitored for maintenance, usage, or other purposes. However, in view of manufacturer differences relating to hardware devices and interfaces, it may be difficult for a monitoring device to communicate with various other devices connected to a network. Such a disadvantage can prevent the obtaining of information crucial to effective monitoring of computer networks.

### SUMMARY OF THE INVENTION

According to one example of the invention, code for use in instructing components in a network monitoring system is provided. The components include at least one data gatherer for gathering operation data from a monitored network constituent. A main computer system has a database for storing the operation data. A data forwarder permits communication of the operation data from the data gatherer to the computer system. The computer system is remotely located from the data gatherer. The code includes information for creating custom tables in the database to hold the operation data. Information permits the data gatherer to selectively gather the operation data from other possible data that is capable of being gathered from the monitored constituent.

According to another example of the invention, an article of manufacture for a network monitoring system is provided. The network monitoring system includes at least one data gatherer for gathering operation data from a monitored network constituent. A main computer system has a database for storing the operation data. A data forwarder permits communication of the operation data from the data gatherer to the computer system. The computer system is remotely located from the data gatherer. The article of manufacture includes at least one process readable carrier and code. The code includes information for creating custom tables in the database to hold the operation data. The code further includes information permitting the data gatherer to selectively gather the operation data from other possible data that is capable of being gathered from the monitored network constituent.

According to another example of the invention, a computer implemented monitoring system method is carried out on a main computer system of a network monitoring system. The computer system has a database. The method includes the steps of parsing code on the computer system. The code is written in a universal description language and is for operating the computer system. The method also includes the step of creating custom tables in the database to hold operation data corresponding to at least one monitored network constituent in at least one client network. The method also includes the step of obtaining the operation data from the client network.

### BRIEF DESCRIPTION OF THE DRAWINGS

These and other advantages of the invention will become apparent upon reading the following detailed description and upon referring to the drawings in which:

FIG. 1 is a simplified diagram of a network architecture, a probe and an agent of an embodiment of the present invention being shown in the diagram;

FIG. 2 is a relationship diagram illustrating subsystems within a remote management location server according to an embodiment of the present invention; and

FIG. 3 is an entity relationship diagram illustrating tables for storing universal services in a data management system (DMS) according to an embodiment of the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings may have been given the same reference numeral or similar reference numerals. Arrow heads of connector lines in the drawings indicate the flow of instructions, information and/or data in at least the direction of the arrow head. In this application, the term service is to be given a broad meaning in the context of the device(s) and/or software providing the service(s). Local service monitoring refers to self-monitoring, and remote service monitoring refers to the monitoring of other devices.

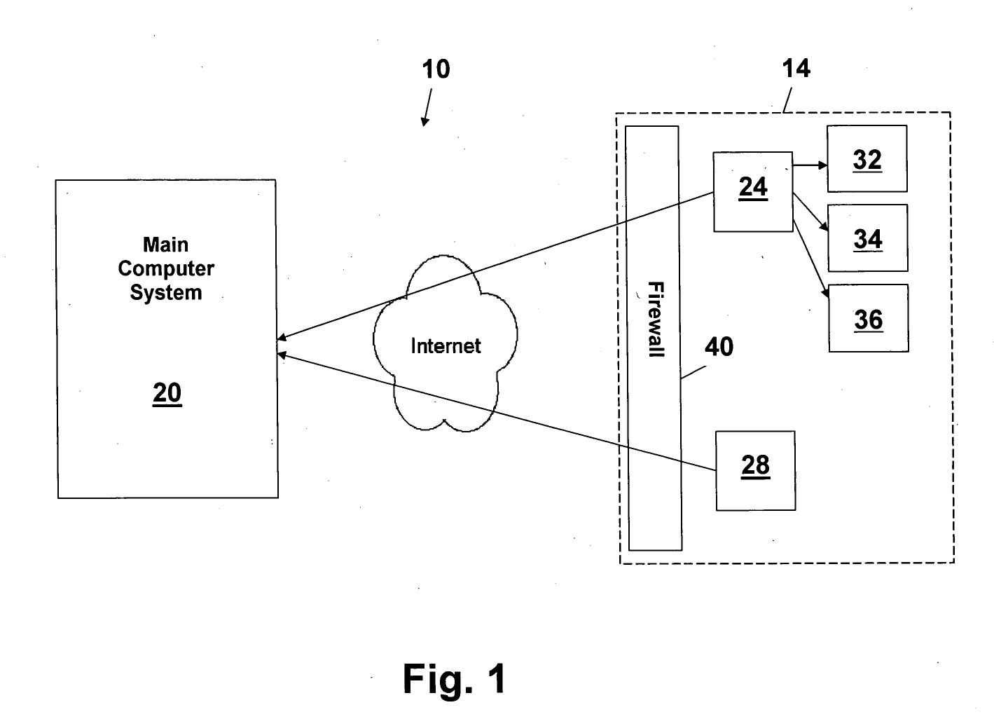

A network architecture 10 is illustrated in FIG. 1. In this Figure, computer network 14 can be located at a location different from a main computer system 20 (i.e. the computer system 20 is in a remote management location). Although only one client network 14 is illustrated, it will be appreciated that alternative network architectures could include any number of networks similar to the network 14.

Within the network 14 are one or more probes 24, and one or more agents 28. A computer platform can comprise the agent 28. In one embodiment, an appliance can comprise probe 24. The probe 24 and the agent 28 can monitor constituents within the network 14 using various protocols, including standard protocols such as Simple Network Management Protocol (SNMP) and Windows Management Instrumentation (WMI).

In an example of the present invention, a gatherer of operation data (or data gatherer) is one or more modules. The probe 24 and the agent 28 each load a module. The module scans a device/service combination, and metrics are returned. For example, the probe 24 can obtain operation data from monitored network constituents such as switch/router 32, a printer 34 and a server/workstation 36. It will be understood that network constituents can include more than physical stand alone devices on the network. For example, a hard disk on a computer could be a network constituent, and so too could a file stored on a computer-readable medium.

Metrics obtained from the modules loaded on the probe 24 and the agent 28 are transmitted to the remote computer system 20. Specifically, the probe 24 or the agent 28 originates the connection in order to go through firewalls (e.g. firewall 40). Thus, the probe 24 and the agent 28 are also data forwarders. It will be understood that a network monitoring system could be constructed in which other components could function as data forwarders.

Data collected by the probe 24 and the agent 28 is transferred to the remote computer system 20 via simple object access protocol (SOAP) messages; however, it will be appreciated that this particular type of Extensible Markup Language (XML) protocol is not the only type of protocol that could be used to transmit the collected data.

In an embodiment of the present invention, three important subsystems are a user interface (UI), a DMS and probe/agents. As previously described, the probes and agents exist all around client networks. The UI and the DMS exist on one or more servers within the remote computer system 20.

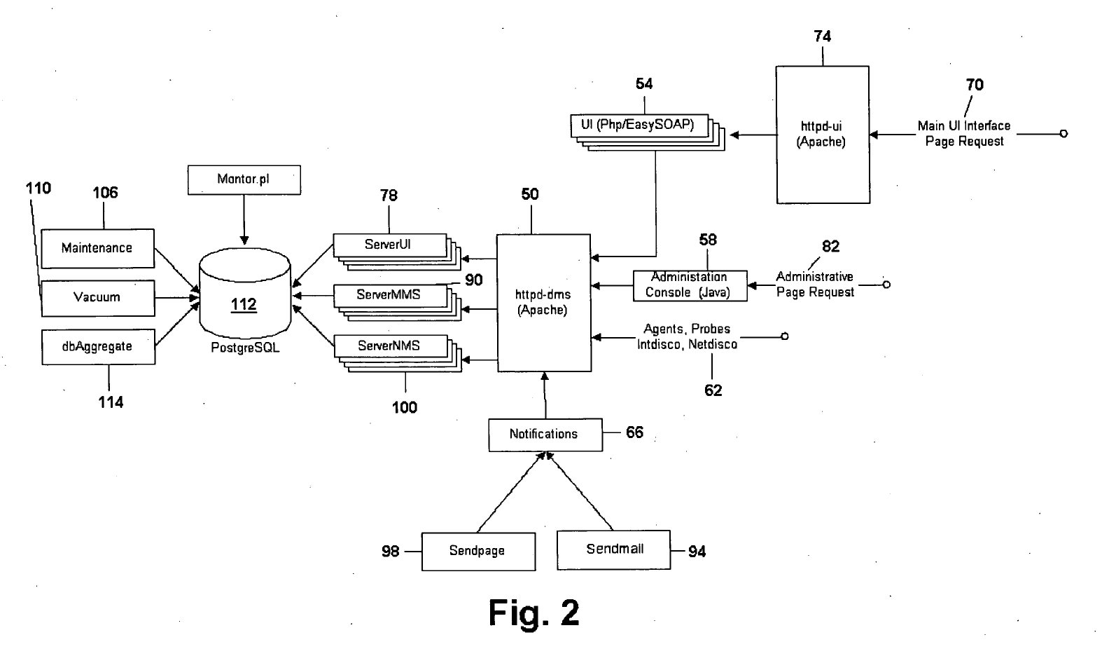

FIG. 2 is a relationship diagram illustrating an embodiment of a suitably programmed and configured server for the remote computer system 20. Hypertext Transfer Protocol daemon (HTTPd) 50 can receive requests from any of UI component or process 54, administration console 58, and entities (agents, probes, Intdisco, Netdisco) 62 and notification management system (NMS) 66.

With respect to the UI component 54, this can receive an interface page request 70 forwarded from an HTTPd 74. The UI component 54 can send a request to the HTTPd 50 which can be forwarded to ServerUI process 78. The UI component 54 can use a DMS application programming interface (API) presented by the ServerUI process 78.

With respect to the administration console 58, this can handle an administrative page request 82. The administrative page request 82 can be forwarded by the HTTPd 50 to the ServerUI process 78. The administrative console 58 can use a DMS API presented by the ServerUI process 78.

With respect to the entities 62, these will also transmit requests to the HTTPd 50. Requests from entities 62 will be received by a ServerMMS process 90. The entities 62 use a DMS API presented by the ServerMMS 90.

Intdisco is a special purpose agent designed to discover interfaces that reside on a given device or appliance. Netdisco is another special purpose agent designed to query a network using a variety of protocols in order to determine devices that exist on the network. These agents may assist in a rapid setup of the network monitoring system.

Requests from the NMS 66 originate from the action of either Sendpage subcomponent 98 or Sendmail subcomponent 94. Requests from the NMS 66 are forwarded by the HTTPd 50 to a ServerNMS process 100. The NMS 66 uses a DMS API presented by the ServerNMS process 100.

There are API's between the UI 54 and the DMS, between the administrative console 58 and the DMS, and between the agents/probes and the DMS. During communications various SOAP functions are called.

The processes 78, 90 and 100 perform operations on a relational database 112. One skilled in the art will appreciate that various possible relational databases could be used; however, PostgreSQL is preferred in one embodiment of the invention. PostgreSQL implements an extended subset of American National Standards Institure (ANSI) Structured Query Language (SQL) and runs on many platforms. It also has interfaces to many different programming languages and database protocols, like Open Database Connectivity (ODBC) and Java Database Connectivity (JDBC).

Subcomponents Maintenance 106, Vacuum 110 and dbAggregate 114 can also perform operations on the PostgreSQL 112. For example, the Vacuum 110 performs periodic system maintenance on the database to facilitate its continued healthy operations. In addition, a variety of processes or subprocesses besides those illustrated can perform operations on the PostgreSQL as will be appreciated by one skilled in the art of software engineering.

Custom tables are created in the database for the operation data gathered by the data gatherers. In one embodiment, the information for creating these tables are contained in code written in an XML based language. This code can be written on a processor readable carrier. Possible processor readable carriers include random access memory; a hard disk drive, a compact disk and a compact disk recordable. Other well known processor readable carriers are also possible.

Agent/Probe Communication

When an agent/probe desires to initiate a new session with the DMS, it will call the SOAP function Session.Hello( ). The DMS will verify all the business rules that apply to the agent and if it passes, will grant it a session id. Specific rules checked include the following:
Is the ApplianceID valid
Does the Appliance have a current SessionID—Each appliance is only allowed to have one concurrent session.

When an agent/probe desires to load its configuration, SOAP functions Appliance.Config( ), Module.List( ), and Module.Update( ) will be called. In order to successfully call these functions, the agent/probe must have a valid session id. These calls can give the agent everything it requires to fully configure itself.

When a probe/agent desires to load its tasks, SOAP functions Appliance.Config( ), Module.List( ), and Module.Update( ) will be called. In order to successfully call these functions, the agent must have a valid session id.

All incoming data is validated by various rules which can include:
SessionID is validated
ApplianceID is validated
Task must belong to appliance submitting the database
Task must not be deleted
Cooked data must pass type checking

Invalid tasks will be passed back in an array called invalid tasks. Those tasks will be removed from the scheduler.

Anatomy of a Universal Service

There is an internal structure associated with the storing and manipulation of services in the system. In one embodiment, the internal structure is as follows:

Dashboard

A dashboard is a high level display grouping. (It will be understood that sometimes a unified display in a software product that aims to integrate information from multiple components is termed a dashboard.)

The dashboard comprises the display screen. It will be appreciated that this layer could be created externally, and there can also be a number of internal ID references.

Aggregate Service

This portion of the internal structure helps to deal with limited display space (columns) on dashboards. An aggregate service is a collection of similar services that provides horizontal aggregation in the UI based on-board categories of services (e.g. E-mail). The intent is that within broad categories, multiple services can generically be rolled up (e.g. SMTP, POP, IMAP are all e-mail related services).

There could also be the need for a service collection. In one embodiment, the service collection would allow the creation of functional groupings of services.

Service

A service (in the context of one embodiment of the anatomy of a universal service) is an aggregate of scan details and corresponds to UI presentation on the dashboard. The service can be an aggregation of gathered metrics, or scan details that are gathered by a module and displayed on a given dashboard within a given meta-service.

A service definition allows the defining of the basic characteristics about the service. These characteristics can include:

Storage tables—where gathered metrics should be stored within the database

Time-to-Stale—how long gathered metrics are considered relevant or fresh.

Display Characteristics—including aggregation of data or tasks, description, display name

Exportable—Export the gathered metrics to 3rd party databases.

How to relate scan details for state—Worst case (OR), Inclusive (AND) or gradient (%).

Module

The module (type and instance) is a collection base-engine, essentially, the implementation. There is more than one of these per service, one for each target operating system. This is transparent to the outside user. It dictates which probe or agent can run the service, not how it is configured. The modules can encapsulate both the engine and the definition. The modules allow the service definition to be expressed separately.

Modules can be implemented inside or outside of the core system. Implementing modules outside of the core system is advantageous where it is desired to have customers build their own modules. Where modules are implemented inside the core system, custom module development can be done through service packs.

Configuration details are dictated by the module. External representation could be a useful way to encapsulate the configuration schema and help for configuring a service.

Scan Detail

A scan detail or gathered metrics: it is possible to have more than one scan detail in a service. In one embodiment, the most severe state is what gets displayed in the UI.

Scan details are the base data collection units but they are not presentation units (in one embodiment the service comprises the presentation units). Also, scan details are cooked data as generated by the Module. The operation data is extractable from the scan details. The Scan Detail can provide all the required information of the UI to be able to display the collected metrics intelligently.

Threshold

In one example of the invention, means for the DMS to make intelligent decisions on collected data includes thresholds. Thresholds describe to the system how to translate gathered metrics or scan details, to service status.

The thresholds include information for how the UI should present the thresholds. In one embodiment, the ability to customize or reverse the threshold application is provided.

Parameters

Parameters or configuration describe to the UI what the user must provide in order to setup an instance of this service. It also describes to an agent module everything it requires in order to gather the scan details and return them to the DMS.

Code includes information permitting the data gatherer to selectively gather the operation data from other possible data that is capable of being gathered from the monitored constituent.

One skilled in the art will appreciate that a variety of grammars can be used here.

The information that the module requires to identify what it needs to gather can be expressed in a fixed manner, or a more universal language could be used. In one embodiment, the parameters provide information for how the UI should display the configuration to the user to allow them to configure a service, how the UI will verify the user input, and how the DMS will differentiate between multiple instances of the configured service.

Task

The task is an actual instantiation of the defined universal service, which is assigned to a agent or probe in order for that agent or probe to gather the scan details as defined by the service. The task is a configured service.

Management

It is important that each object be uniquely identifiable. ID values are used for tracking purposes, and an ID range can be used to categorize the ID values and how they are allowed to be used.

In one embodiment, the ID values are:

| | |
|---|---|
| DashboardID | to identify which dashboard the service should be |
| | displayed on. |
| ServiceID | aggregate presentation unit. |
| ScanDetailID | data gathering unit. |
| ParameterID | configuration unit. |

In one embodiment, the categories for the ID values are:

| | |
|---|---|
| 0-9999 | Internal. These are only created by the maker of the software |
| | and internal to the product. These values are at the lower end |
| | of the range as this encompasses all of the internally defined |
| | ID values for service types and scan details. |
| 10000- | Certified. These are only created by the software maker as |
| 19999 | universal services. A new scan detail ID would have a value in |
| | this range. |
| 20000- | Uncertified. These can be created by customers. |
| 29000 | |
| 30000- | Test. These cannot be installed on production equipment. |
| 39000 | |
| other | Reserved. |

In one embodiment, all ID values will be able to be used in universal services (i.e. references). Nevertheless, ID restrictions should be enforced on creation of new ID values at install time, disallowing definition of certified IDs in uncertified packages, uncertified IDs in certified packages and internal IDs in all universal services.

IDs should not be reused: ID values should be retired when the objects are. Otherwise migration becomes complicated.

Format and Syntax

A syntax that is portable and extensible should be used for the format of the service definition. The file should preferably not be edited, except by approved service development tools. In one embodiment, the file should not be editable in any way after release.

In a preferred embodiment of the invention, the format is XML. XML is extensible. An XML Schema Definition (XSD), Schema and style sheets can facilitate the creation of custom authoring tools. One skilled in the art will appreciate that by using a suitable XSD file, the DMS can verify that a given service is well formed, and that none of the required elements are missing or incorrect before the DMS imports the service.

In order to improve portability of the syntax, implementation dependent data internal to the server is not included (only data necessary to the high level definition of the service).

Some services may have installation dependent parameters. For instance, a remote system log pattern will require the IP address/host name of the remote system, a string of the form “<hostname>. *ERROR”. It is possible to leave the host name for post-installation configuration through the UI. However, it is desirable to support configuration variables. A syntax similar to shell scripts is one possibility (e.g. “${hostname}. *ERROR”). A syntax for variables can support immediate needs and any future needs. Another approach to the remote system log monitoring would be to extend one of the modules (e.g. a module designed to gather data from either regularly appended log files, or batch files) to link the task configuration to the hostname in the device configuration.

In an example implementation of an example service in the service description language, the code, which can be contained in an XML file, is as follows:

<?xml version=“1.0” encoding=“UTF-8” ?>
- <service author=“John Sproull” creationdate=“01/21/2004”
organization=“N-able Technologies” syntaxversion=“1.0.0.0”
version=“1.0.0.0” xmlns=“http://www.n-able.com”
xmlns:xsi=“http://www.w3.org/2001/XMLSchema-instance”
xsi:schemaLocation=“http://www.n-able.com file:////src/Development-
4.5/n-central/dms/ncsai/etc/custom_service.xsd”>
- <servicedefinition customservice=“false” dashboardid=“1”
dbtable=“datacpu” exportable=“true” id=“111” isgenericservice=“false”
reason=“” releasedependency=“4.5.0.0” servicetype=“Local”
version=“1.0.0.0”>

<description country=“ca” language=“en”>Cpu</description>
<displayname country=“ca” language=“en”>CPU</displayname>
<help country=“ca” language=“en” />
<popuphelp country=“ca” language=“en” />
<serviceparameters aggregatedata = “true” aggregatetasks=“false”

maxinstances=“8” maxpollrate=“30” minpollrate=“5”
schedulertype=“Interval Based Scheduler” serviceinstancetype=“Single”
timetostale=“30” />
- <scandetails>

<scandetailid>11100</scandetailid>
</scandetails>

- <moduleparameters>
- <moduleparameter key=“scan_interval” max=“” min=“”
phardcoded=“false” preferredident=“false” type=“Integer” value=“5”>

<shortdescription country=“ca” language=“en”>Scan

Interval</shortdescription>

<longdescription country=“ca” language=“en”>Number of minutes

between scans</longdescription>

<help country=“ca” language=“en”>The scanning interval is the

number of minutes between scans.</help>

</moduleparameter>

- <moduleparameter key=“CPU” max=“3” min=“0” phardcoded=“false”
preferredident=“true” type=“Integer” value=“0”>

<shortdescription country=“ca” language=“en”>Monitored

CPU</shortdescription>

<longdescription country=“ca” language=“en”>The ID number of the

processor.</longdescription>

<help country=“ca” language=“en”>This field displays the ID

number of the processor.</help>

</moduleparameter>
</moduleparameters>
</servicedefinition>

- <scandetail id=“11100” processforstate=“true”
releasedependency=“4.5.0.0” version=“1.0.0.0”>
- <thresholddefaults>
- <thresholds configurable=“true” type=“Percentage”>

<threshold high=“85” low=“0” state=“Normal” />
<threshold high=“95” low=“80”state=“Warning” />
<threshold high=“100” low=“90” state=“Failed” />
</thresholds>
</thresholddefaults>
<description country=“ca” language=“en”>CPU Usage (%)
</description>
<help country=“ca” language=“en”>Help</help>
<popuphelp country=“ca” language=“en”>Popup Help</popuphelp>
<displayname country=“ca” language=“en”>CPUP</displayname>
</scandetail>
</service>

Upgradeability

It is advantageous for service definitions to be easily changed. It will be understood that security monitoring is more dynamic than network monitoring.

It is possible to upgrade a service definition. It is also possible to uninstall a service definition. It will be understood that parameters should not necessarily be overwritten when a task is upgraded because the service definition is upgraded. The designer of the service should preferably be able to decide what the appropriate action is. It is desirable to bring the task configuration forward wherever possible.

Upgrades may also be required during development of services as they are created, tested, tweaked and retested.

Forward and Backward Compatibility

One skilled in the art will appreciate the issues surrounding migration of files. In particular, migrating files can be an expensive and error prone process.

It is common practice to have forward and backward compatibility. For instance, ID3v1 and ID3v2 tags in the MP3 file format. The authoring tools cooperate intelligently to support both the newer richer tagging syntax while allowing the MP3 files to work equally well in all versions of players. In one embodiment of the invention, there is forward and backward compatibility of service definition files. At the low level, this can be achieved by having version and dependency fields in the data definition; however, it will be understood that there are other solutions.

Forward and backward compatibility comes from having some flexibility in the XML parsing. In one embodiment, the DTD is permissive enough to allow both the forward and backward compatibility.

Internationalization

Textual package data can be stored in a form that allows other languages besides English to be supported. Unicode and XML are compatible with some constraints as noted by the W3C in the technical note “Unicode in XML and other Markup Languages”.

In addition to the ability to code languages other than English, internationalization of a product requires support for multiple languages. Textual package data is preferably grouped by language code.

A grouping of textual data by language code [ISO 639] is the logical solution. For example, one embodiment of in the service definition section, there are four textual fields (Description, DisplayName, Help, PopupHelp). One instance of each of these would exist for each language supported.

For example:

| Language | | | |
|---|---|---|---|
| Code | Item | Data Fields | |
| en | English | Description, DisplayName, | English language |
| | Text | Help, PopupHelp | versions of these |
| | | | fields |
| de | German | Description, DisplayName, | German language |
| | Text | Help, PopupHelp | versions of these |
| | | | fields |

There should be a high level element for each language instance.

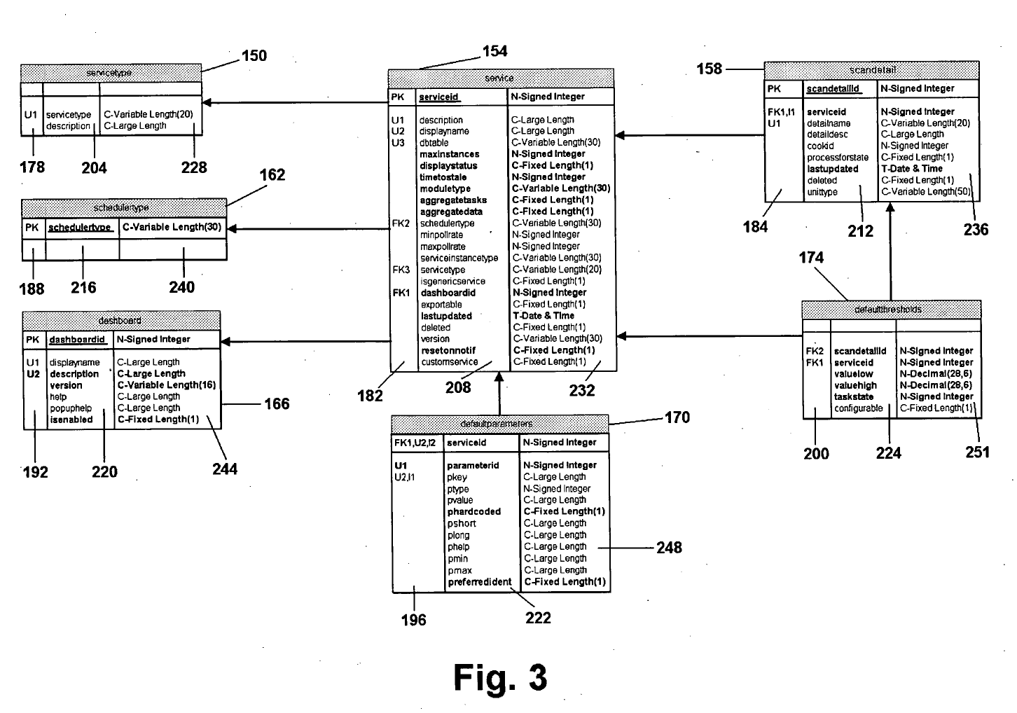

FIG. 3 is an entity relationship diagram illustrating example tables for storing universal services in the DMS. The tables illustrated are servicetype table 150, service table 154, scandetail table 158, schedulertype table 162, dashboard table 166, defaultparameters table 170 and default-thresholds table 174. Columns 178, 182, 184, 188, 192, 196 and 200 are columns where keys are shown for the particular table (associated with attributes). Columns 204, 208, 212, 216, 220, 222, and 224 list attributes for the particular tables. The columns 228, 232, 236, 240, 244, 248 and 251 are the third columns shown for each of the tables, and these columns list type information (i.e. each of the attributes listed in the second column have a particular type). The arrows in FIG. 3 illustrate relationships.

One skilled in the art will appreciate that the DMS will have additional tables not illustrated in FIG. 3, and these additional tables need not be described in this application. Furthermore, the tables shown in FIG. 3 are only example tables, and the DMS could have entirely different tables if desired.

Thus, it is apparent that there has been provided in accordance with the invention an apparatus and method for monitoring network resources that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. Code for use in instructing components in a network monitoring system, the components including at least one data gatherer for gathering operation data from a monitored network constituent, a main computer system having a database for storing the operation data, and at least one data forwarder permitting communication of the operation data from the data gatherer to the computer system, the computer system being remotely located from the data gatherer, the code comprising:
information for creating custom tables in said database to hold said operation data; and
information permitting said data gatherer to selectively gather said operation data from other possible data that is capable of being gathered from said monitored constituent.

2. Code as claimed in claim 1 wherein the code is written in a universal service description language.

3. Code as claimed in claim 1 wherein the code is written in a service description language.

4. Code as claimed in claim 3 further comprising instructions for storing said operation data in said tables.

5. Code as claimed in claim 2 wherein said operation data comprises data indicating availability of a device on a client network.

6. Code as claimed in claim 2 wherein said universal service description language is an XML based language.

7. Code as claimed in claim 1 further comprising instructions permitting intelligent interpretation of said operation data.

8. Code as claimed in claim 7 further comprising rules for refreshing said operation data.

9. Code as claimed in claim 2 wherein said monitored constituent is a device, and said data gatherer is within said monitored constituent.

10. Code as claimed in claim 2 wherein said data gatherer functions within an appliance.

11. An article of manufacture for a network monitoring system, the network monitoring system including at least one data gatherer for gathering operation data from a monitored network constituent, a main computer system having a database for storing the operation data, and at least one data forwarder permitting communication of the operation data from the data gatherer to the computer system, the computer system being remotely located from the data gatherer, the article of manufacture comprising at least one processor readable carrier and code, said code including information for creating custom tables in said database to hold said operation data, and said code further including information permitting said data gatherer to selectively gather said operation data from other possible data that is capable of being gathered from said monitored constituent.

12. An article of manufacture as claimed in claim 11 wherein said code is written in a service description language.

13. An article of manufacture as claimed in claim 11 wherein said code is written in a universal description language.

14. An article of manufacture as claimed in claim 13 wherein said universal description language is an XML based language.

15. An article of manufacture as claimed in claim 11 wherein said processor readable carrier comprises a selected one of random access memory, a hard disk drive, a compact disk and a compact disk recordable.

16. An article of manufacture as claimed in claim 11 wherein said code further comprises instructions for storing said operation data in said tables.

17. A computer-implemented monitoring system method carried out on a main computer system of a network monitoring system, the computer system having a database and the method comprising the steps of:
parsing code on said computer system, said code written in a universal service description language and for operating said computer system;
creating custom tables in said database to hold operation data corresponding to at least one monitored network constituent in at least one client network; and
obtaining said operation data from said client network.

18. A method as claimed in claim 17 wherein said computer system is a server and said database is a PostgreSQL database.

19. A method as claimed in claim 17 further comprising the step of storing said operation data in said tables.

20. A method as claimed in claim 19 further comprising the step of applying predefined rules upon said operation data, at least before the step of storing said operation data.

21. A method as claimed in claim 20 further comprising the step of providing a notification when a failure threshold corresponding to at least one of said pre-defined rules has been reached.

22. A method as claimed in claim 17 wherein said client network and said computer system are communicatively linked by the internet.

23. A method as claimed in claim 17 wherein said operation data is obtained from SOAP message transmissions.

24. A method as claimed in claim 23 wherein said universal service description language is an XML based language.
